(19) United States
(12) Patent Application Publication
(10) Pub. No.: US 2007/0195397 A1
(43) Pub. Date: Aug. 23, 2007

(54) SEMICONDUCTOR OPTICAL MODULATION DEVICE

(75) Inventor: Norio OKADA, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: MITSUBISHI ELECTRIC CORPORATION, Tokyo (JP)

(21) Appl. No.: 11/530,533

(22) Filed: Sep. 11, 2006

(30) Foreign Application Priority Data
Feb. 23, 2006 (JP) 2006-046992

(51) Int. Cl. G02F 1/01

(52) U.S. Cl. 359/240

(57) ABSTRACT

A semiconductor optical modulation device includes a semiconductor optical modulator, an input terminal which is connected to a drive circuit for supplying an electrical signal to the semiconductor optical modulator, an output terminal which is connected to a terminating resistor, an input wire which connects the input terminal to an electrode of the semiconductor optical modulator, and an output wire which connects the output terminal to the electrode of the semiconductor optical modulator. In addition, an additional capacitor or an additional resistor is disposed between the input terminal and the output terminal, and connected in parallel with a series circuit including the input wire and the output wire.

### FIELD OF THE INVENTION

The present invention relates to a semiconductor optical modulation device for generating modulated optical signals modulated based on external electrical signals.

### BACKGROUND ART

A conventional semiconductor optical modulation device is disclosed in, for example, a publication of Japanese Patent Laid-open No. 1-192188.

This kind of semiconductor optical modulation device comprises a semiconductor optical modulator, an input terminal which is connected to a drive circuit for supplying an electrical signal to this semiconductor optical modulator, an output terminal which is connected to a terminating resistor, an input wire which connects the input terminal to an electrode of the semiconductor optical modulator, and an output wire which connects the output terminal to the electrode of the semiconductor optical modulator.

In a conventional semiconductor optical modulation device of this kind, it was difficult to ensure broadband matching due to the parasitic inductance of the input and output wires in addition to the parasitic capacitance and resistance of the semiconductor optical modulator.

### SUMMARY OF THE INVENTION

Accordingly, the purpose of the present invention is to propose an improved semiconductor optical modulation device capable of attaining broadband impedance matching.

According to one aspect of the present invention, a semiconductor optical modulation device comprises a semiconductor optical modulator having an electrode, an input terminal for connection to an outside drive circuit for supplying an electrical signal to the semiconductor optical modulator, an output terminal, a terminating resistor connected to the output terminal, an input wire connecting the input terminal to the electrode of said semiconductor optical modulator, an output wire connecting the output terminal to the electrode of the semiconductor optical modulator, and an additional capacitor or additional resistor disposed between the input terminal and the output terminal. The additional capacitor or additional resistor is connected in parallel with the series circuit comprising the input wire and the output wire.

A semiconductor optical modulation device according to the present invention can achieve broadband matching up to high frequency range, since an additional capacitor or resistor, which is connected in parallel with the series circuit of the input and output wires, decreases the overall impedance of the semiconductor optical modulation.

Other and further objects, features and advantages of the invention will appear more fully from the following description.

### BRIEF DESCRIPTION OF THE DRAWINGS

FIG. 1 is an electrical circuit diagram showing a semiconductor optical modulation device according to a first embodiment of the present invention.

FIG. 2 is a Smith chart showing reflection characteristics of a conventional device obtained by removing the additional capacitor 8 from the circuit of FIG. 1 for comparison.

FIG. 3 is a Smith chart showing reflection characteristics of the first embodiment.

FIG. 4 is an electrical circuit diagram showing a semiconductor optical modulation device according to a second embodiment of the present invention.

FIG. 5 is a Smith chart showing reflection characteristics of the second embodiment.

FIG. 6 is an electrical circuit diagram showing a semiconductor optical modulation device according to a third embodiment of the present invention.

FIG. 7 is a Smith chart showing reflection characteristics of the third embodiment.

FIG. 8 is a top view of a semiconductor optical modulation device according to a fourth embodiment of the present invention.

FIG. 9 shows a top view of a semiconductor optical modulation device according to a fifth embodiment of the present invention.

FIG. 10 shows a top view of a semiconductor optical modulation device according to a sixth embodiment of the present invention.

FIG. 11 shows a top view of a semiconductor optical modulation device according to a seventh embodiment of the present invention.

FIG. 12 is a Smith chart showing reflection characteristics of the seventh embodiment.

FIG. 13 shows a top view of a semiconductor optical modulation device according to an eighth embodiment of the present invention.

FIG. 14 shows a top view of a semiconductor optical modulation device according to a ninth embodiment of the present invention.

FIG. 15 is a bottom view of the internal transmission line 60A in the ninth embodiment.

### DETAILED DESCRIPTION OF THE PREFERRED EMBODIMENTS

Preferred embodiments of the present invention will be described below with reference to the drawings.

### First Embodiment

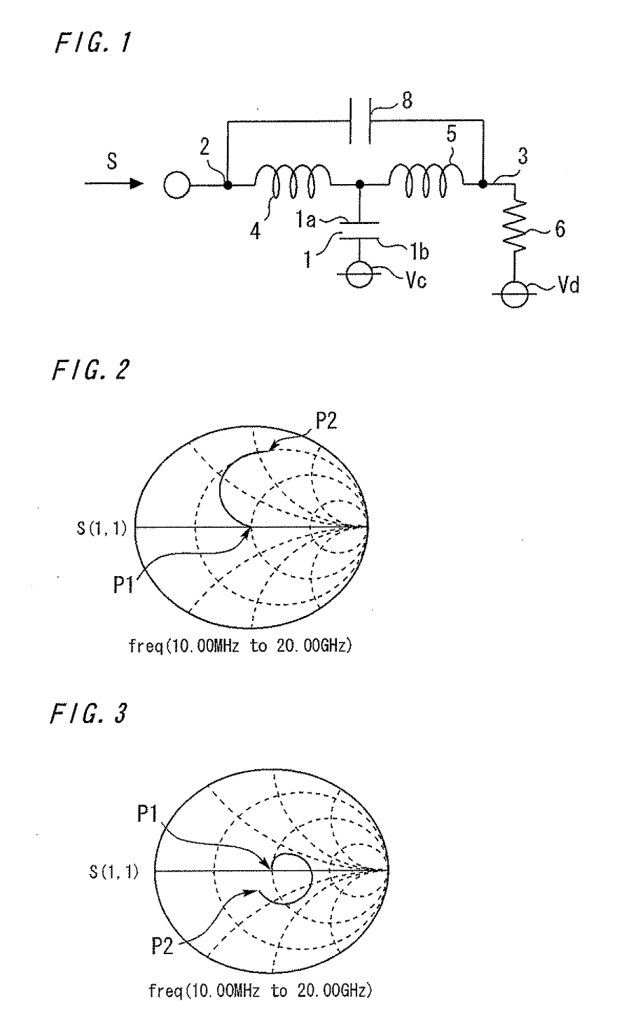

FIG. 1 is an electrical circuit diagram showing a semiconductor optical modulation device according to a first embodiment of the present invention. This semiconductor optical modulation device of the first embodiment comprises a semiconductor optical modulator 1, an input terminal 2, an output terminal 3, an input wire 4, an output wire 5, a terminating resistor 6 and an additional capacitor 8.

The semiconductor optical modulator 1 is comprised of a semiconductor laser with a pair of electrodes 1a and 1b, and generates an optical signal modulated based on an electrical signal S supplied between these electrodes 1a and 1b. A reference voltage Vc is provided to the electrode 1b of the semiconductor optical modulator 1.

An electrical signal S is supplied to the input terminal 2 from a drive circuit, for example, a driver IC, not shown in the figure. This electrical signal S includes frequency components from, for example, DC (direct current) to 15 GHz. The terminating resistor 6 is connected to the output terminal 3. This terminating resistor 6 has a resistance oft for example, 50 O. A reference voltage Vd is provided to the opposite end of this terminating resistor 6. The reference voltage Vd may be equal to the reference voltage Vc, although it may be different.

The input wire 4 is a thin metal wire to connect the electrode 1a of the semiconductor optical modulator 1 to the input terminal 2. Likewise, the output wire 5 is a thin metal wire to connect the electrode 1a of the semiconductor optical modulator 1 to the output terminal 3. Between the input terminal 2 and the output terminal 3, the input wire 4 and the output wire 5 are connected in series. Namely, a series circuit comprising the input wire 4 and the output wire 5 is formed between the input terminal 2 and the output terminal 3.

The additional capacitor 8 is disposed between the input terminal 2 and the output terminal 3, and is connected in parallel with the series circuit comprising the input wire 4 and the output wire 5. This additional capacitor 8 is configured to have capacitance of, for example, 0.05 to 040 pF. Specifically, the additional capacitor 8 is formed to have 0.15 pF.

Assume that Z denotes the overall impedance of the semiconductor optical modulation device shown in FIG. 1. This overall impedance Z may be expressed as Z=X+jY, where X and Y are its real and imaginary components, respectively. This overall impedance Z is designed to match the terminating resistor 6. Making the real component X closer to the resistance of the terminating resistor 6 and the imaginary component Y closer to 0 realizes optimal matching.

FIG. 2 provides a Smith chart showing reflection characteristics of a conventional device obtained by removing the additional capacitor 8 from the circuit of FIG. 1 for comparison. In the Smith chart with horizontal real and vertical imaginary axes, if a plot or locus moves rightward, the real component X becomes larger. Likewise, if the plot moves upward, the imaginary component Y becomes larger. In the Smith chart of FIG. 2, the overall impedance Z is plotted from a start point P1 to an end point P2. The start point P1 corresponds to the overall impedance Z when the electrical signal to the semiconductor optical modulator 1 is DC (direct current). The end point P2 corresponds to the overall impedance Z when the electrical signal is a 20 GHz signal. For reference, the frequency at the start point P1 or the end point P2 is common respectively in FIGS. 3, 5, 7 and 12 as in FIG. 2.

In the Smith chart of FIG. 2, the end point P2 is located almost right above the start point P1 as a result of clockwise upward movement. That is, as the frequency of the electrical signal S is raised, the imaginary component Y of the overall impedance Z grows in the positive direction.

Generally, the inductive and capacitive components of impedance are respectively expressed as jωL and 1/jωC. The inductive component grows upward on the imaginary axis while the capacitive component grows downward below the imaginary axis. In the Smith chart of FIG. 2, as the frequency of the electrical signal S is raised, the inductive component of the overall impedance Z increases since the inductances of the input wire 4 and output wire 5 increase.

Capacitance of the additional capacitor 8 in the first embodiment decreases as the frequency of the electrical signal S is raised. However, the additional capacitor 8 serves to move the overall impedance Z downward across the imaginary axis, since the additional capacitor 8 is connected in parallel with the series circuit of the input wire 4 and the output wire 5.

FIG. 3 is a Smith chart showing reflection characteristics of the first embodiment. In the Smith chart of FIG. 3, the end point P2 is located to the lower left of the start point P1. The pot or locus is closer to the center of the circle than in the Smith chart of FIG. 2. If the plot or locus goes closer to the center of the circle of the Smith chart, then the degree of matching gets better. Therefore, it is understood that the degree of matching is improved as compared with the Smith chart of FIG. 2.

As described above, in the first embodiment, matching can thus be improved by the additional capacitor 8, which is connected in parallel with the series circuit comprising the input wire 4 and output wire 5.

### Second Embodiment

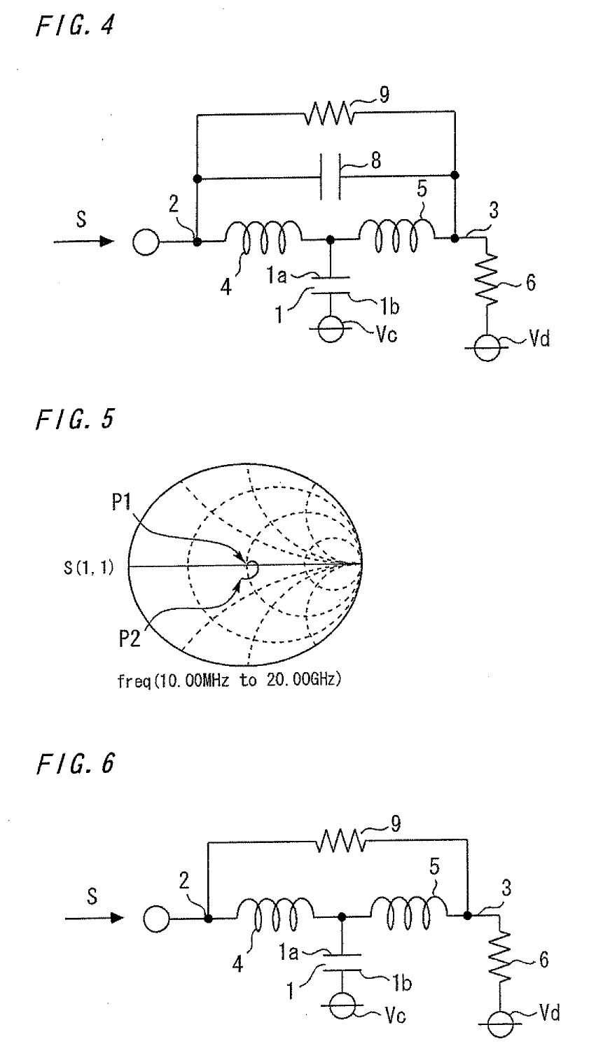

FIG. 4 is an electrical circuit diagram showing a semiconductor optical modulation device according to a second embodiment of the present invention. This semiconductor optical modulation device of the second embodiment comprises an additional resistor 9 in addition to an additional capacitor 8 included in the semiconductor optical modulation device of the first embodiment. Except for the additional resistor 9, this semiconductor optical modulation device has the same configuration as the first embodiment. Further, the additional capacitor 8 connected in parallel with the series circuit of the input wire 4 and output wire 5 is formed to have the same capacitance as in the first embodiment.

The additional resistor 9 is disposed between the input terminal 2 and the output terminal 3. The additional resistor 9 is connected in parallel with the series circuit comprising the input wire 4 and the output wire. Therefore, the additional resistor 9 is also connected in parallel with the additional capacitor 8. The additional resistor 9 is configured to have resistance of, for example, 100 to 1000 O. Specifically, the additional resistor 9 is formed to have a resistance of 300 O.

FIG. 5 is a Smith chart showing reflection characteristics of the second embodiment. Like in the Smith chart of FIG. 3, the end point P2 of the plot is located to the lower left of the start point P1. However, the plot is still closer to the center of the circle of the Smith chart than in FIG. 3. In the Smith chart of FIG. 5, the plot advances clockwise from the start point P1 to the end point P2 almost without departing from the center of the circle at a smaller radius of curvature than in FIG. 3.

In this semiconductor optical modulation device of the second embodiment, the additional resistor 9 reduces the overall impedance Z so that the imaginary component Y of the overall impedance Z can be reduced more than the first embodiment as apparent from the locus in FIG. 5. Thus, the second embodiment can provide a still better matching.

### Third Embodiment

FIG. 6 is an electrical circuit diagram showing a semiconductor optical modulation device according to a third embodiment of the present invention. In this third embodiment, an additional resistor 9 is used in place of the additional capacitor 8 of the first embodiment. In other words, the third embodiment is obtained by removing the additional capacitor 8 from the second embodiment. In the other respects, the third embodiment has the same configuration as the first and second embodiments. The additional resistor 9 is connected in parallel with the series circuit comprising the input wire 4 and output wire 5, and has the same resistance as in the second embodiment.

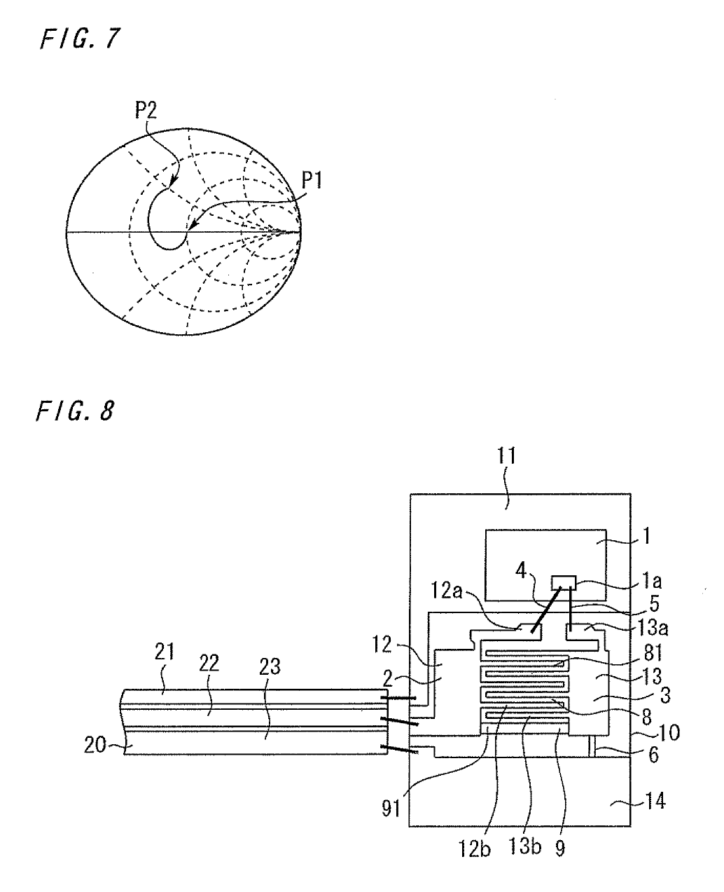

FIG. 7 is a Smith chart showing reflection characteristics of the third embodiment. In the Smith chart of FIG. 7, the end point P2 is located to the upper left of the start point P1. The plot is closer to the center of the circle than that in the Smith chart of FIG. 2. While the imaginary component increases in the Smith chart of FIG. 2, the overall impedance Z in the Smith chart of FIG. 7, obtained with the additional resistor 9, changes clockwise around the center of the circle. This relatively reduces the imaginary component and locates the plot closer to the center of the circle.

Thus in the third embodiment, matching can be improved by the additional resistor 9 which is connected in parallel with the series circuit comprising the input wire 4 and output wire 5.

### Fourth Embodiment

FIG. 8 is a top view of a semiconductor optical modulation device according to a fourth embodiment of the present invention. This fourth embodiment is a specific and actual application of the first embodiment.

The semiconductor optical modulation device of the fourth embodiment comprises a circuit board 10 and a transmission line 20. The circuit board 10 has four mutually independent conductive patterns 11, 12, 13 and 14 on its principal surface. A semiconductor optical modulator 1 is located on the conductive pattern 11 in the upper area. An electrode 1a of the semiconductor optical modulator 1 is formed at a part of its top surface. The other electrode 1b of the semiconductor optical modulator 1 is formed at a bottom whole surface and connected to the conductive pattern 11.

In the middle area of the circuit board 10, the conductive patterns 12 and 13 are formed so as to horizontally face each other The conductive pattern 12 constitutes an input terminal 2 while the conductive pattern 13 constitutes an output terminal 3. The conductive patterns 12 and 13 respectively have an input pad 12a and an output pad 13a on their upper ends and comb-shaped patterns 12b and 13b below the pads. The input pad 12a is connected to the electrode 1a of the semiconductor optical modulator 1 by an input wire 4. The output pad 13a is connected to the electrode 1a of the semiconductor optical modulator 1 by an output wire 5. An inter-pattern capacitor 81 is formed due to the comb-shaped portions 12b and 13b whose teeth are alternately extended toward each other. This inter-pattern capacitor 81 serves as the additional capacitor 8. The inter-pattern capacitor 81 has the same capacitance as the additional capacitor 8 of the first embodiment.

A terminating resistor 6 is located between the conductive pattern 13 and the conductive pattern 14 formed in the lower area of the circuit board 10. This terminating resistor 6 is a thin film resistor to connect the conductive patterns 14 and 13. A transmission line 20 is, for example, a matched coplanar transmission line having three mutually insulated connecting lines 21, 22 and 23. These connecting lines 21, 22 and 23 are extended in parallel. The connecting lines 21, 22 and 23 are connected to the conductive patterns 12, 13 and 14, respectively. The transmission line 20 is connected to a drive IC not shown in the figure. An electrical signal S from this drive IC is supplied to the conductive pattern 12 via the connecting line 22, then to the electrode 1a of the semiconductor optical modulator 1. The connecting line 21 supplies reference voltage Vc to the conductive pattern 11, while the connecting line 23 supplies reference voltage Vd to the conductive pattern 14.

In the fourth embodiment, the inter-pattern capacitor 81 is formed between the conductive patterns 12 and 13 on the circuit board 10. By this inter-pattern capacitor 81 serving as the additional capacitor 8, matching can be improved in the same manner as in the first embodiment.

A thin film resistor 91 may be formed below the inter-pattern capacitor 81 as the additional resistor 9 of the second embodiment. The thin film resistor 91 is formed so as to extend from the conductive patterns 12 to 13 in parallel with the inter-pattern capacitor 81. This thin film resistor 91 has the same resistance as the additional resistor 9 of the second embodiment. By adding the thin film resistor 91 serving as the additional resistor 9, the semiconductor optical modulation device of the second embodiment is actually realized.

### Fifth Embodiment

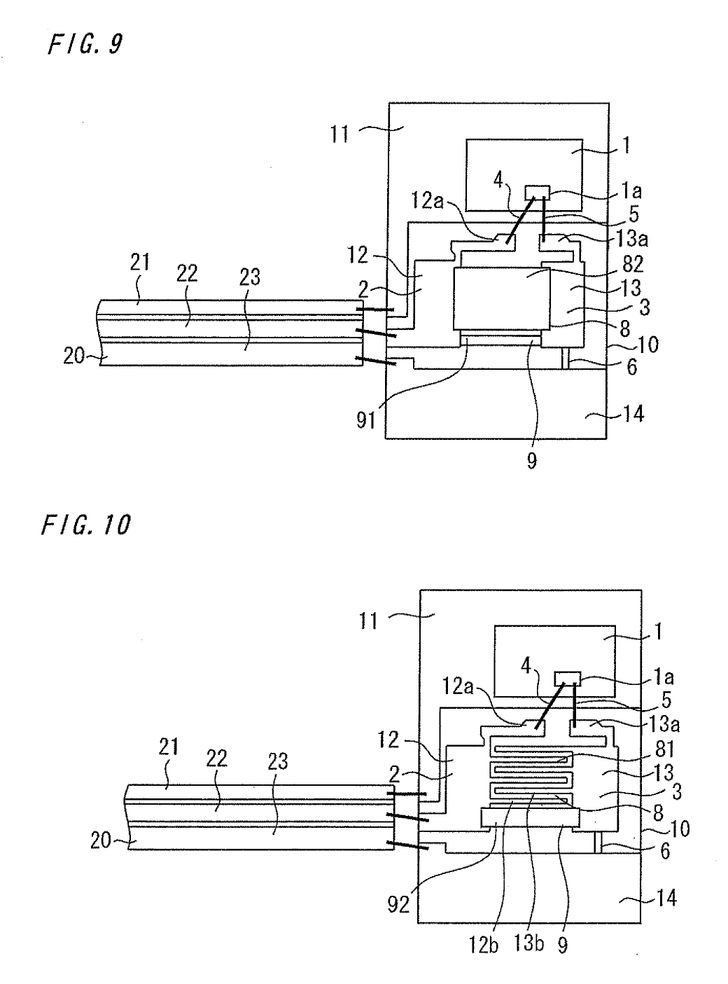

FIG. 9 shows a top view of a semiconductor optical modulation device according to a fifth embodiment of the present invention. This fifth embodiment is another specific application of the first embodiment. While the fourth embodiment has the additional capacitor 8 formed between the conductive patterns 12 and 13 on the circuit board, the fifth embodiment 5 has a chip capacitor 82 disposed between the conductive patterns 12 and 13 on the circuit board 10. This chip capacitor 82 constitutes the additional capacitor 8 and provides the same capacitance as the additional capacitor 8 in the second embodiment. In the other respects, the fifth embodiment has the same configuration as the fourth embodiment.

The chip capacitor 82 is disposed so as to extend from the conductive pattern 12 to 13 on the circuit board 10. The chip capacitor 82 has a pair of electrodes that are respectively connected to the conductive patterns 12 and 13.

In the fifth embodiment, the chip capacitor 82 is disposed between the conductive patterns 12 and 13 on the circuit board 10. The chip capacitor 82 serves as the additional capacitor 8, and matching can be improved in the same manner as in the first embodiment.

A thin film resistor 91 may be formed below the chip capacitor 82 as the additional resistor 9. The thin film resistor 91 is formed so as to extend from the conductive pattern 12 to 13 in parallel with the chip capacitor 82. This thin film resistor 91 provides the same resistance as the additional resistor 9 in the second embodiment. By adding the thin film resistor 91 serving as the additional resistor 9, it is possible to construct the second embodiment.

### Sixth Embodiment

FIG. 10 shows a top view of a semiconductor optical modulation device according to a sixth embodiment of the present invention. This sixth embodiment is a specific and actual application of the second embodiment. In this sixth embodiment, an inter-pattern capacitor 81 is formed as the additional capacitor 8 by comb-shaped portions 12b and 13b of the conductive patterns 12 and 13 on the circuit board 10 as in the fourth embodiment, and a chip resistor 92 is disposed as the additional resistor 9 below the inter-pattern capacitor 81. The inter-pattern capacitor 81 provides the same capacitance as the additional capacitor 8 of the second embodiment. The chip resistor 92 provides the same resistance as the additional resistor 8 of the second embodiment. In the other respects, the sixth embodiment has the same configuration as the fourth embodiment.

The chip resistor 92 is disposed so as to extend from the conductive patterns 12 to 13 on the circuit board 10. The chip resistor 92 is provided with a pair of electrodes that are respectively connected to the conductive patterns 12 and 13.

In the sixth embodiment, the inter-pattern capacitor 81 is formed as the additional capacitor 8 between the conductive patterns 12 and 13 on the circuit board 10 and the chip resistor 92 is disposed as the additional resistor 9 between the conductive patterns 12 and 13 on the circuit board. Thus, matching can be improved as much as in the second embodiment.

The chip resistor 92 in FIG. 10 may be removed. In this case, by the inter-pattern capacitor 81 formed as the additional capacitor 8 between the conductive patterns 12 and 13 on the circuit board 10, matching can be improved as much as in the first embodiment.

### Seventh Embodiment

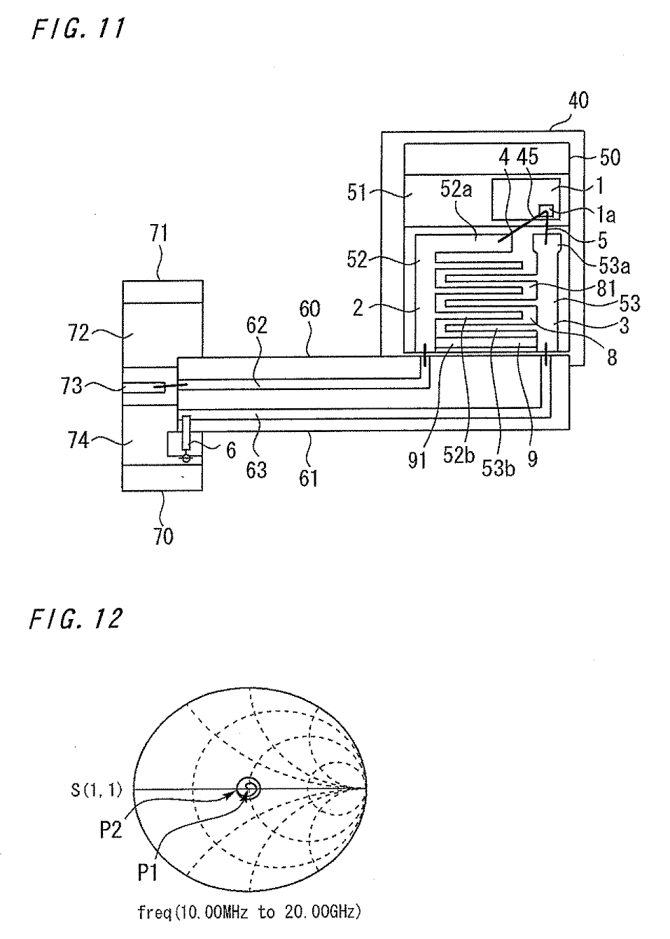

FIG. 11 shows a top view of a semiconductor optical modulation device according to a seventh embodiment of the present invention. In this seventh embodiment, a semiconductor optical modulator 1 disposed on a circuit board 50, and the circuit board 50 is mounted on a Peltier device 40, and an internal transmission line 60 and an external transmission line 70 are combined thereto.

The Peltier device 40 is formed in a rectangle larger than the circuit board 50. The circuit board 50 is mounted on the top surface of this Peltier device. The semiconductor optical modulator 1 is mounted on the circuit board 50. In the upper area of the top surface of the circuit board 50, a conductive pattern 51 is formed. In the lower area, conductive patterns 52 and 53 are formed as well. The bottom electrode 1b of the semiconductor optical modulator 1 is joined to the conductive pattern 51.

Below the conductive pattern 51, the conductive patterns 52 and 53 are formed so as to horizontally face each other. The conductive pattern 52 constitutes an input terminal 2 while the conductive pattern 53 constitutes an output terminal 3. The conductive patterns 52 and 53 respectively have an input pad 52a and an output pad 53a on their upper ends and comb-shaped portions 52b and 53b below the pads. The input pad 52a is connected to the electrode 1a of the semiconductor optical modulator 1 by an input wire 4. The output pad 53a is connected to the electrode 1a of the semiconductor optical modulator 1 by an output wire 5. The input wire 4 and the output wire 5 are formed by bonding a common wire 45 to the electrode 1a of the semiconductor optical modulator 1 and then bending either end about the bonding point. Alternatively, the input wire 4 and the output wire 5 may be constituted from separate wires as in the fourth through sixth embodiments. An inter-pattern capacitor 81 is formed due to the comb-shaped portions 52b and 53b whose teeth are alternately extended toward each other. This inter-pattern capacitor 81 serves as the additional capacitor 8. The inter-pattern capacitor 81 is connected in parallel with the series circuit comprising the input wire 4 and the output wire 5, and the inter-pattern capacitor 81 provides the same capacitance as the additional capacitor 8 in the first embodiment.

Below the inter-pattern capacitor 81, a thin film resistor 91 is disposed as the additional resistor 9 between the conductive patterns 52 and 53. This thin film resistor 91 is connected in parallel not only with the series circuit comprising the input wire 4 and the output wire but also with the inter-pattern capacitor 81.

The internal transmission line 60 is a matched microstrip line having two conductive lines 62 and 63 formed on its elongated insulated baseboard 61. The conductive line 62 constitutes the input transmission line while the conductive line 63 constitutes the output transmission line. The conductive lines 62 and 63 are separately extended in parallel to each other. The right end of the conductive line 62 is connected to the conductive pattern 52 while the right end of the conductive line 62 is connected to the conductive pattern 53. On the bottom side of the insulated baseboard 61, a GND conductive line (earth conductive line) is formed so as to cover the whole surface. The right end portion of the internal transmission line 60 is set on the top surface of the Peltier device 40 so that the bottom side GND conductive line of the insulated baseboard 61 is kept in contact with the lower area of the Peltier device 40. Impedance of the internal transmission line 60 is determined depending on the relation of the conductive lines 62 and 63 and the GND conductive line on the bottom side of the insulated baseboard 61.

The external transmission line 70 is, for example, a matched coplanar transmission line. The external transmission passage 70 is mounted under the left end portion of the internal transmission line 60 in overlapping manner. The external transmission passage 70 has three mutually insulated conductive patterns 72, 73 and 74 formed on its top surface. The conductive patterns 72 and 74 are connected to GND, and are set in contact with the GND conductive line formed on the bottom surface of the insulated baseboard 61 of the internal transmission line 60. The conductive pattern 73 is formed between the conductive patterns 72 and 74 in parallel with them. The conductive pattern 73 is connected to the left end of the conductive line 62 of the internal transmission line 60. The conductive pattern 73 is also connected to a drive IC not shown in the figure. Electrical signal S from this drive IC is supplied to the electrode 1a of the semiconductor optical modulator 1 via the conductive line 62 and the conductive pattern 52 on the circuit board 50. A terminating resistor 6 is disposed between the conductive pattern 74 of the external transmission line 70 and the conductive line 63 of the internal transmission line 60. This terminating resistor 6 is located at the left end of the internal transmission line 60. Therefore, the terminating resistor 6 is distant from the Peltier device 40 by almost the same length as the internal transmission line 60.

While the semiconductor optical modulator 1 is operating, the Peltier device 40 cools the semiconductor optical modulator 1, the inter-pattern capacitor 81 and the thin film resistor 91 disposed on the Peltier device 40. The Peltier device 40 keeps the semiconductor optical modulator 1 at a certain temperature during its operation.

The terminating resistor 6 is better positioned close to the semiconductor optical modulator 1 to the extent possible to prevent electrical multi-reflection with respect to the semiconductor optical modulator 1. However, if the terminating resistor 6 is located on the Peltier device 40, the power consumption of the Peltier device 40 should be raised, since the Peltier device 40 must cool the heat generated by the resistor 6. Therefore, in the seventh embodiment, the terminating resistor 6 is located outside the Peltier device 40 in order to prevent the increase of the power consumption by Peltier device 40. Thus, the terminating resistor 6 is connected via the conductive line 63 of the matched internal transmission line 60. Deterioration of reflection characteristics is not caused, since the internal transmission line 60 is matched.

FIG. 12 is a Smith chart showing reflection characteristics of the seventh embodiment. In the Smith chart of FIG. 12, the plot or locus moves with a small radius of curvature from the start point P1, which is at the center of the circle, to the end point P2. It is understood that deterioration in reflection characteristics is not shown as compared with the Smith chart of FIG. 5.

Thus, the semiconductor optical modulation device of the seventh embodiment can improve the degree of matching while reducing the power consumption of the Peltier device 40 by locating the terminating resistor 6 outside the Peltier device 40.

### Eighth Embodiment

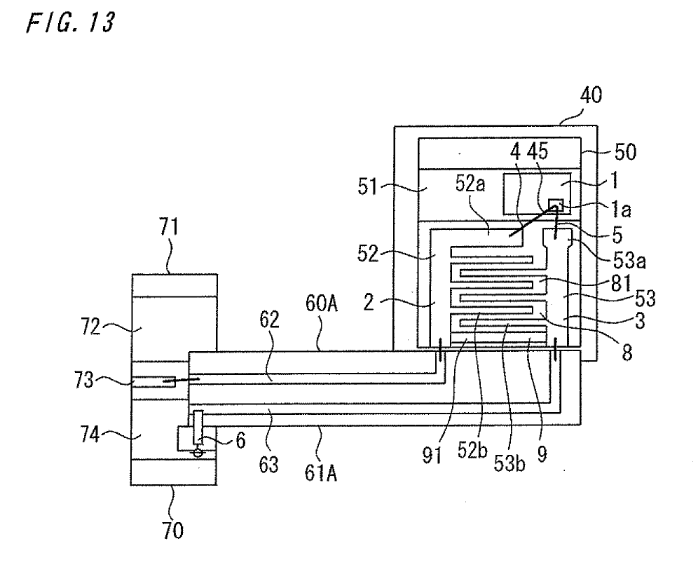

FIG. 13 shows a top view of a semiconductor optical modulation device according to an eighth embodiment of the present invention. This eighth embodiment is different from the seventh embodiment in that a low thermal conductivity flexible baseboard 61A is used to form its internal transmission line 60A instead of an internal transmission line 60 in the seventh embodiment. In the other respects, the eighth embodiment has the same configuration as the seventh embodiment.

The internal transmission line 60A adopts a low thermal conductivity elongate flexible baseboard 61A in place of the insulated baseboard 61 of the seventh embodiment, so that the thermal conduction between the terminating resistor 6 and the semiconductor optical modulator 1 is further reduced. Therefore, the amount of heat transferred from the terminating resistor 6 to the semiconductor optical modulator 1 is further reduced, and the power consumption of the Peltier device 40 is further reduced.

### Ninth Embodiment

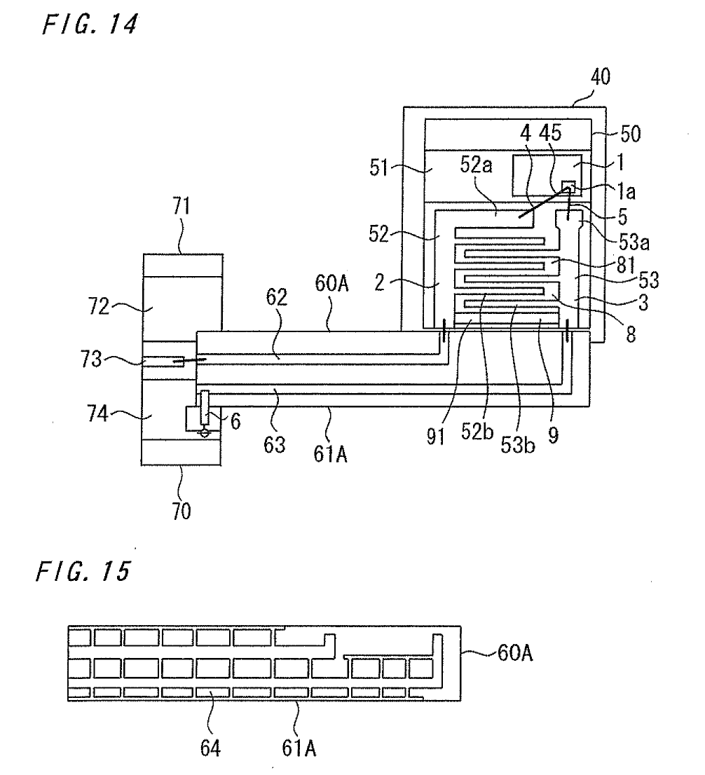

FIG. 14 shows a top view of a semiconductor optical modulation device according to a ninth embodiment of the present invention. FIG. 15 is a bottom view of the internal transmission line 60A in this ninth embodiment. In the ninth embodiment, the bottom side GND conductive line 64 of the insulated baseboard 61A of the internal transmission line 60A is formed like a lattice as shown in FIG. 15. In the other respects, the ninth embodiment has the same configuration as the eighth embodiment. The internal transmission line 60A of the ninth embodiment also uses a low thermal conductivity flexible baseboard 61A.

The GND conductive line 64 of the internal transmission line 60A is formed like a lattice, so that its thermal conductivity is lowered. Therefore, the amount of heat transferred from the terminating resistor 6 to the semiconductor optical modulator 1 is further reduced, and the power consumption of the Peltier device 40 is further reduced.

As understood from the detailed description above, with respect to the industrial field of application, the semiconductor optical modulation device according to the present invention can be applied to any field where an optical signal needs to be generated in response to a modulating electrical signal.

Obviously many modifications and variations of the present invention are possible in the light of the above teachings. It is therefore to be understood that within the scope of the appended claims the invention may by practiced otherwise than as specifically described.

The entire disclosure of a Japanese Patent Application No. 2006-046992, filed on Feb. 23, 2006 including specification, claims, drawings and summary, on which the Convention priority of the present application is based, are incorporated herein by reference in its entirety.”

1. A semiconductor optical modulation device comprising:
a semiconductor optical modulator having an electrode;
an input terminal for connection to an outside drive circuit for supplying an electrical signal to said semiconductor optical modulator;
an output terminal;
a terminating resistor connected to said output terminal;
an input wire connecting said input terminal to said electrode Of said semiconductor optical modulator;
an output wire connecting said output terminal to said electrode of said semiconductor optical modulator; and
at least one of a capacitor and a resistor disposed between said input terminal and said output terminal, said at least one of a capacitor and a resistor being connected in parallel with a series circuit comprising said input wire and said output wire.

2. The semiconductor optical modulation device according to claim 1, including both of said capacitor and said resistor disposed between said input terminal and said output terminal and connected in parallel with said series circuit comprising said input wire and said output wire.

3. The semiconductor optical modulation device according to claim 1, comprising said capacitor and a circuit board for mounting said semiconductor optical modulatory; wherein said capacitor is an inter-pattern capacitance between a pair of conductive patterns on said circuit board.

4. The semiconductor optical modulation device according to claim 1, including said capacitor wherein said capacitor is a chip capacitor.

5. The semiconductor optical modulation device according to claim 1, including said resistor wherein said resistor is a thin film resistor.

6. The semiconductor optical modulation device according to claim 1, including said resistor wherein said resistor is a chip resistor.

7. The semiconductor optical modulation device according to claim 1, further comprising a Peltier device and a transmission line having a conductive line, wherein said semiconductor optical modulator is mounted on said Peltier device and said output terminal is connected to said terminating resistor via said conductive line of said transmission line.

8. The semiconductor optical modulation device according to claim 7, wherein said transmission line includes a flexible baseboard.

9. The semiconductor optical modulation device according to claim 8, wherein said transmission line comprises a ground conductor having a lattice shape.
